(19) United States
(12) Patent Application Publication
(10) Pub. No.: US 2026/0061790 A1
(43) Pub. Date: Mar. 5, 2026

(54) Autonomous Trailer Stabilization System

(71) Applicants: Morgan Kemp, Clinton, UT (US); Tupou Fonokalfi, Clinton, UT (US)

(72) Inventors: Morgan Kemp, Clinton, UT (US); Tupou Fonokalfi, Clinton, UT (US)

(21) Appl. No.: 19/043,702

(22) Filed: Feb. 3, 2025

Related U.S. Application Data
(60) Provisional application No. 63/687,336, filed on Aug. 27, 2024.

(51) Int. Cl. B60D 1/30; B60D 1/32

(52) U.S. Cl. CPC B60D 1/305; B60D 1/32

(57) ABSTRACT

The present invention is a trailer stabilization system to enhance road safety by monitoring and stabilizing diesel or camping trailers. The system includes sensors for detecting trailer instability, such as swaying or tipping caused by wind, uneven road surfaces, or sudden movements. A control module utilizes artificial intelligence algorithms, analyzes sensor data to predict and respond to instability by activating robotic arms that apply corrective forces to restore balance. The system also features deployable wheels to stabilize the trailer when detached from the towing vehicle, as well as a hitch coupler capable of secure coupling and controlled detachment during emergencies. The system includes hazard signaling items, comprising flashing lights and audio alerts which are configured to automatically warn surrounding drivers of potential dangers when sensors detect swaying or tipping. A GPS module provides real-time location data, and compact lithium-ion batteries provide electric power to the system.

### CROSS-REFERENCE TO RELATED APPLICATION

The present application claims priority to, and the benefit of, U.S. Provisional Application No. 63/687,336 which was filed on Aug. 27, 2024, and is incorporated herein by reference in its entirety.

### FIELD OF THE INVENTION

The present invention generally relates to safety systems for trailers towed by vehicles. More specifically, the invention relates to a trailer stabilization system designed to enhance road safety and prevent instability during towing or stationary use. The system integrates with trailers and includes a plurality of sensors configured to detect swaying, tipping, or other destabilizing forces in real time. A control module equipped with artificial intelligence analyzes sensor data and activates corrective mechanisms, including robotic arms that apply precise counterforces to stabilize the trailer. The system also incorporates hazard signaling items, such as flashing lights and audio alerts, to warn or alert surrounding drivers of potential dangers. Accordingly, the present disclosure makes specific reference thereto. Nonetheless, it is to be appreciated that aspects of the present invention are also equally applicable to other like applications, devices, and methods of manufacture.

### BACKGROUND

By way of background, a trailer is an unpowered vehicle that is towed by another powered vehicle. Trailers are used for transporting various items such as cargo, livestock, and more. Trailer instability is a critical issue encountered during towing operations and often leads to dangerous situations for both the driver and surrounding road users. Trailers are particularly susceptible to tipping over when parked on slopes or soft ground, where uneven support and shifting weight can compromise their balance. In such scenarios, even moderate external forces, such as wind or accidental impacts, can destabilize the trailer, resulting in physical damage to the trailer, the towing vehicle, or nearby structures, and posing significant risks of injury to individuals.

Environmental factors such as wind can exacerbate the instability. Strong gusts can create sway or even overturn a trailer, especially if the trailer lacks a robust stabilization system. Furthermore, accidental impacts, such as a vehicle grazing the trailer or sudden jolts, can dislodge the trailer and trigger tipping, which may lead to hazardous road conditions. Another major factor that causes the trailer instability is unequal weight distribution. When the trailer's load is improperly balanced, it amplifies the risk of sway during towing and increases the likelihood of tipping during parking or sudden movements. Uneven loading shifts the center of gravity, making the trailer more prone to oscillations or tipping under external forces. Individuals desire a comprehensive stabilization system capable of monitoring and addressing trailer instability in real time.

Therefore, there exists a long-felt need in the art for a system that can address the issues of sway and tipping, which are frequently caused by external factors such as strong winds, uneven road surfaces, or improper weight distribution. Specifically, there is a long-felt need for a system that performs real-time monitoring and stabilization mechanisms for trailers. Furthermore, there is a long-felt need for a system that can automatically respond to emergency situations, such as trailer detachment during extreme instability, to prevent further risks to the trailer and other vehicles. Additionally, there is a need for integrated safety features that alert surrounding drivers to potential hazards caused by trailer instability. Moreover, there is a need for a versatile trailer stabilization system that can be easily incorporated into new trailers during manufacturing or retrofitted onto existing trailers as an aftermarket accessory. Finally, there is a need for a safety system that improves roadway safety for both the trailer owner and other motorists.

The subject matter disclosed and claimed herein, in one embodiment, comprises a trailer stabilization system designed to monitor, stabilize, and ensure the safety of trailers during towing or stationary use. The system includes a plurality of sensors configured to detect instability, such as swaying or tipping, caused by wind, uneven terrain, or sudden movements. These sensors transmit real-time data to a control module, which processes the information using artificial intelligence algorithms to predict and respond to instability. The system further includes a plurality of robotic arms strategically positioned along the trailer frame. These arms are designed to apply corrective forces, counteracting sway and restoring balance. The system also features hazard signaling items, including flashing lights and noise producing speakers, which are automatically activated to alert nearby drivers during emergencies.

In this manner, the trailer stabilization system of the present invention fulfills the aforementioned needs by providing a comprehensive solution to the challenges of trailer instability. The system ensures real-time monitoring and intelligent stabilization through the integration of advanced sensors and AI-driven control mechanisms. The system includes robotic arms and deployable wheels to counter sway, tipping, and instability. The system provides stabilization and emergency response and enhances road safety and user confidence, mitigating the risks associated with trailer towing and stationary instability.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trailer stabilization system for monitoring and stabilizing a trailer towed by a towing vehicle. The system comprises a plurality of sensors disposed in the trailer for monitoring trailer stability and detecting swaying or tipping of the trailer, a plurality of robotic arms are disposed along a frame of the trailer, the robotic arms are configured to counteract swaying of the trailer and maintain balance by applying corrective forces, a control module is configured to analyze data from the sensors and control the robotic arms to stabilize the trailer, a plurality of signaling items comprises hazard lights and noise producing speakers, the signaling items are automatically activated to alert surrounding vehicles upon detection of swaying or tipping by the sensors, and power source is configured to supply electric power to the sensors, robotic arms, control module, and signaling items.

In another aspect, a trailer stabilization system for use with a trailer towed by a towing vehicle is disclosed. The system includes a plurality of sensors configured to detect swaying, tipping, or instability in the trailer caused by external conditions, a control module is operatively connected to the sensors and configured to provide control signals based on data received from the sensors, a plurality of robotic arms are disposed along the frame of the trailer, the robotic arms are actuated in response to the control signals to counteract sway and restore trailer stability, a plurality of deployable wheels are configured to be automatically activated by the control module when the trailer is detached from the towing vehicle, and a trailer hitch coupler is configured to enable secure coupling of the trailer to the towing vehicle and to decouple the trailer under control of the control module during unsafe conditions.

In one embodiment, a trailer stabilization system for a trailer towed by a towing vehicle is disclosed. The system includes a plurality of sensors disposed on the trailer for detecting instability, including swaying or tipping of the trailer, a control module including artificial intelligence algorithms is configured to analyze data from the sensors to detect patterns indicating instability, predict potential emergency conditions involving trailer sway or tipping, and generate control signals for stabilizing the trailer. A GPS module is configured to provide real-time location data of the trailer, and a power source is configured to supply power to the sensors, control module, robotic arms, and GPS module.

In yet another aspect, a trailer hitch coupler is configured to secure the trailer to the towing vehicle and to decouple the trailer in response to an emergency condition.

In still another embodiment, the robotic arms further comprise actuators enabling the stabilizing arms 106 to extend, retract, or rotate to apply corrective forces in multiple directions, and wherein the robotic arms are made from materials selected from the group consisting of titanium, aluminum alloy, carbon fiber, high-strength steel, and composite materials.

In yet another embodiment, the signaling items include a combination of LED lights, strobe lights, and rotating beacon lights, and wherein the speakers are configured to generate at least one of alarm tones, pulsing sounds, or prerecorded voice messages to warn or alert surrounding drivers of an emergency condition.

In still another aspect, the artificial intelligence algorithms of the control module are trained using historical data of trailer movements, accidents, and successful stabilization events, and wherein the control module provides push notifications to a software application accessible by a driver or remote user.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of trailer stabilization system of the present invention in accordance with the disclosed architecture;

FIG. 2 illustrates a perspective view showing the robotic arms being deployed in the trailer in accordance with one embodiment of the present invention;

FIG. 3 illustrates a rear perspective view of the trailer equipped with the trailer-mounted system in accordance with the disclosed structure;

FIG. 4 illustrates an enlarged view of the trailer hitch coupler used for coupling the towing vehicle and the trailer in accordance with the disclosed structure; and

FIG. 5 illustrates a flow chart depicting a process of operation of the trailer stabilization system of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that can address the issues of sway and tipping, which are frequently caused by external factors such as strong winds, uneven road surfaces, or improper weight distribution. Specifically, there is a long-felt need for a system that performs real-time monitoring and stabilization mechanisms for trailers. Furthermore, there is a long-felt need for a system that can automatically respond to emergency situations, such as trailer detachment during extreme instability, to prevent further risks to the trailer and other vehicles. Additionally, there is a need for integrated safety features that alert surrounding drivers to potential hazards caused by trailer instability. Moreover, there is a need for a versatile trailer stabilization system that can be easily incorporated into new trailers during manufacturing or retrofitted onto existing trailers as an aftermarket accessory. Finally, there is a need for a safety system that improves roadway safety for both the trailer owner and other motorists.

The present invention, in one exemplary embodiment, is a trailer stabilization system for a trailer towed by a towing vehicle. The system includes a plurality of sensors disposed on the trailer for detecting instability, including swaying or tipping of the trailer, a control module including artificial intelligence algorithms is configured to analyze data from the sensors to detect patterns indicating instability, predict potential emergency conditions involving trailer sway or tipping, and generate control signals for stabilizing the trailer. A GPS module is configured to provide real-time location data of the trailer, and a power source is configured to supply power to the sensors, control module, robotic arms, and GPS module.

Reference will now be made in detail to the present preferred embodiments of the invention, examples of which are illustrated in the accompanying drawings. Wherever possible, the same reference numerals are used in the drawings and the description to refer to the same or like parts.

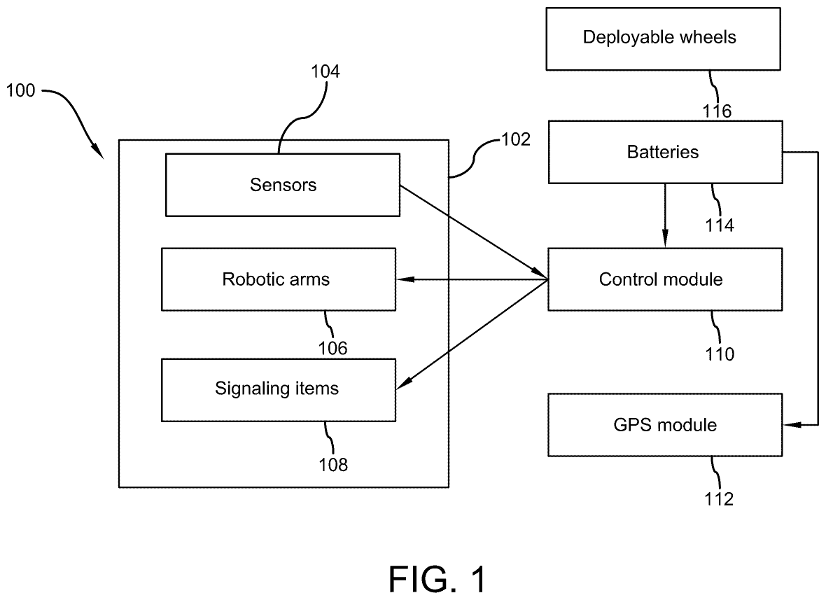

Referring initially to the drawings, FIG. 1 illustrates a schematic view of trailer stabilization system of the present invention in accordance with the disclosed architecture. The trailer stabilization system 100 of the present invention is designed to enhance road safety by monitoring and stabilizing diesel or camping trailers. More specifically, the system 100 stabilizes and, if necessary, safely detaches the trailer from the towing vehicle. The system 100 can be integrated into a trailer and a towing vehicle during manufacturing of the vehicles and can also be used as an aftermarket accessory with existing trailers.

The system 100 includes a trailer-mounted system 102 which includes a plurality of sensors 104 disposed in the trailer for monitoring trailer stability in real time, detecting swaying or tipping of the trailer as caused by wind, uneven road surfaces, or sudden movements. The sensors 104 may include but are not limited to accelerometers to measure acceleration and detect sway or oscillations in the trailer, wind speed and direction sensors to detect crosswinds that may destabilize the trailer. A plurality of robotic or stabilizing arms 106 are disposed along the trailer frame and are configured to counteract swaying and return the trailer to its original position for maintaining balance of the trailer. Preferably, the robotic or stabilizing arms 106 dampen oscillations by applying corrective forces to prevent swaying of the trailer. The position of the robotic or stabilizing arms 106 can vary based on shape and size of the trailer and can be made of one or more of titanium, aluminum, carbon fiber, high-strength steel, or any composite material.

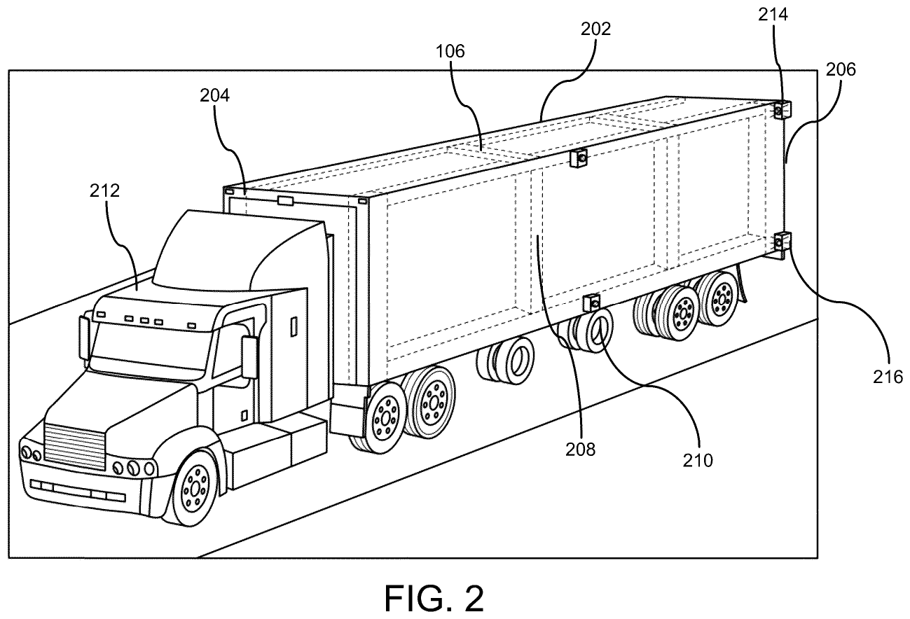

A plurality of signaling items 108 are included in the trailer-mounted system 102. The signaling items may include flashing lights and noise producing speakers (illustrated in FIG. 2) which are configured to warn or alert surrounding drivers of potential dangers and obstructions when the trailer is swaying or tipping. The signaling items 108 are automatically activated when the sensors 104 detect swaying or tipping of the trailer. The hazard lights can be one or combination of LED lights, strobe lights, rotating beacon lights, and sequential lights. The speakers can generate alarm tones, pulsing sounds, horns, and more to alert the surrounding drivers.

A control module 110 which can be a combination of software and hardware is used for analyzing the sensor data from the sensors 104. The control module 110 can be trailer mounted or can also be positioned inside the towing vehicle and provides instruction to the robotic or stabilizing arms 106, signaling items 108, and other structural elements in the trailer to stabilize the trailer. The control module 110 may include machine learning algorithms and artificial intelligence for predicting emergency situations of swaying and tipping of the trailer. The control module 110 may detect patterns indicating instability based on the data received from the sensors and correlates sensor inputs to understand overall trailer behavior. In some embodiments, the control module 110 may provide push notifications to a software application for alerting the driver or any remote user. The control module 110 can be trained on historical data of trailer movements, accidents, and successful stabilizations. Further, the control module 110 performs processing locally for low-latency responses.

A GPS module 112 is configured to provide real-time location of the trailer to aid in recovery and emergency response. One or more batteries 114 are included in the system 100 for providing electric power to different components of the intelligent trailer safety system 100 and the batteries 114 are preferably compact Li-Ion batteries. In the preferred embodiment, the system 100 is automatically activated when the trailer and the towing vehicle activate and electric power from the battery 114 is automatically transmitted to the control module 110, sensors 104, robotic or stabilizing arms 106, signaling items 108, and GPS module 112.

The trailer-mounted system 102 also includes deployable wheels 116 for providing stability to the trailer when the trailer is detached from the towing vehicle for reducing risks of further accidents. The trailer can be automatically detached from the trailer when required for safety of the trailer and surrounding vehicles as described later in the disclosure.

FIG. 2 illustrates a perspective view showing the robotic arms being deployed in the trailer in accordance with one embodiment of the present invention. The trailer-mounted system 102 includes a plurality of robotic or stabilizing arms 106 disposed at strategic locations inside the trailer 202. The robotic or stabilizing arms 106 can be bolted to the trailer 202 (preferably inside the trailer 202) using structural elements like hooks, bolts, and more. Preferably, the robotic or stabilizing arms 106 are in the form of telescoping tubes which can be dimensioned based on size of the trailer 202. Further, the robotic or stabilizing arms 106 can extend from the front end 204 of the trailer 202 to the rear end 206 of the trailer 202. Similarly, the robotic or stabilizing arms 106 can extend across the width of the trailer 202. The robotic or stabilizing arms 106 work to prevent swaying and tipping of the trailer 202 and restore balance of the trailer 202. In the preferred embodiment, the robotic or stabilizing arms 106 move, retract, or extend to counteract the sway of the trailer 202. The robotic or stabilizing arms 106 may include actuators 208 enabling the stabilizing arms 106 to retract or extend.

A plurality of deployable wheels 210 are included in the system 100 for providing movement and stability to the trailer 202, when the trailer 202 is detached from the towing vehicle 212. The deployable wheels 210 can be automatically deployed upon receiving instructions from the control module 110 when the trailer 202 is in a detached state.

The signaling items 108 (FIG. 1) includes a plurality of illumination source 214 and a plurality of speakers 216. The illumination source 214 and the speakers 216 are automatically activated when the sensors 104 detect sway or tipping in the trailer 202. The signaling items 108 provide alerts to the surrounding vehicles and drivers about an emergency. It should be noted that the system 100 provides automatic alerts and safety to the trailer 202 and the surrounding vehicles without requiring the driver of the towing vehicle 212 to manually alert nearby drivers.

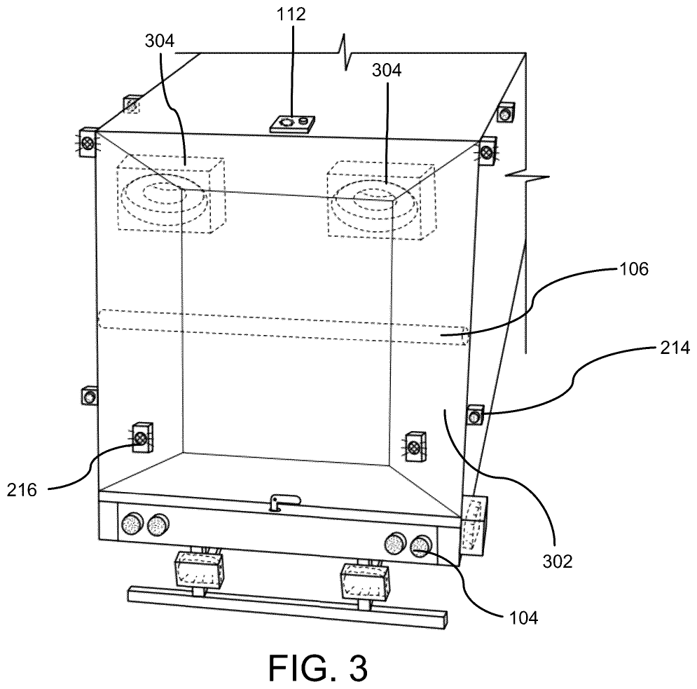

FIG. 3 illustrates a rear perspective view of the trailer 202 equipped with the trailer-mounted system 102 in accordance with the disclosed structure. As illustrated, the trailer 202 includes sensors 104 which can be a combination of different mechanical and environmental sensors as described in FIG. 1. It should be noted that although sensors 104 are shown only on the rear wall 302 of the trailer 202, the sensors 104 can be disposed on any position both inside and on outer surface of the trailer 202.

The GPS module 112 detects real-time location of the trailer 202 and may provide the information to the control module 110, a remote device and a dashboard of the towing vehicle of the trailer 202. For providing effective protection against swaying and tipping of the trailer 202, square cross-sectional tubings 304 are disposed in the trailer 202. The square cross-sectional tubings 304 can be of any size and enables enhanced stability and support to the trailer 202 on uneven tracks and in strong winds.

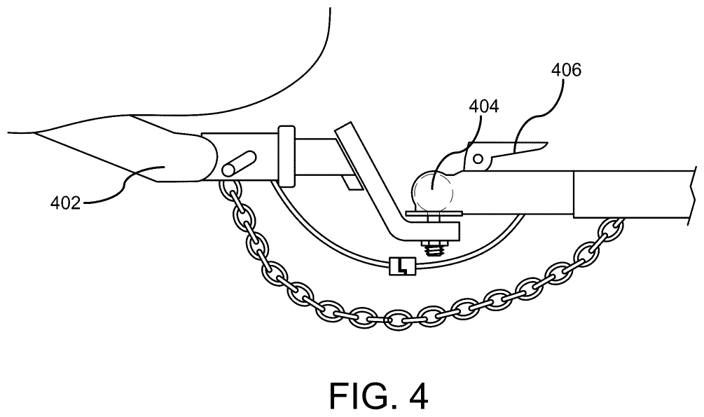

FIG. 4 illustrates an enlarged view of the trailer hitch coupler used for coupling the towing vehicle and the trailer in accordance with the disclosed structure. A truck-side attachment device 402 connects the towing vehicle 212 to the hitch ball 404. A breaker bar 406 helps the trailer 202 from tilting, oscillating, and swaying and detaches the trailer 202 from the towing vehicle 212 in extreme situations where stabilization of the trailer 202 is insufficient. In some embodiments, where the control module 110 is positioned in the towing vehicle 212, an electric connection may connect the control module 110 and the trailer-mounted system 102. The intelligent trailer safety system 100 can also use wireless communication or any other proprietary communication protocol for communication between different components of the system 100.

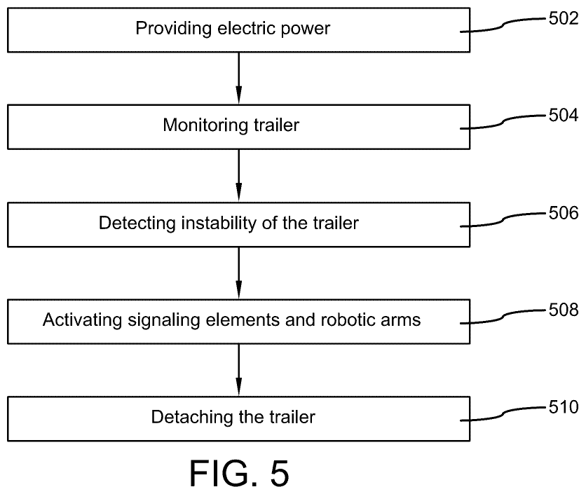

FIG. 5 illustrates a flow chart depicting a process of operation of the trailer stabilization system of the present invention in accordance with the disclosed structure. Initially, electric power is supplied by the lithium-ion battery to all the components of the system (Step 502). Then, sensors continuously monitor stability of the trailer in real time and detect sway, tipping, or instability of the trailer (Step 504). The sensor data is transmitted to the control module and the data is analyzed to detect patterns of instability of the trailer (Step 506). On detection of the instability, robotic arms and signaling elements are activated for providing stability and alerting users (Step 508). During continuous instability and emergency, the control module signals the hitch coupler to safely detach the trailer from the towing vehicle (Step 510).

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trailer stabilization system”, “intelligent trailer safety system”, “trailer monitoring, stabilization, and security system”, and “system” are interchangeable and refer to the trailer stabilization system 100 of the present invention.

Notwithstanding the forgoing, the trailer stabilization system 100 of the present invention can be of any suitable configuration as is known in the art without affecting the overall concept of the invention, provided that it accomplishes the above stated objectives. One of ordinary skill in the art will appreciate that the trailer stabilization system 100 as shown in the FIGS. are for illustrative purposes only, and that many other configurations of the trailer stabilization system 100 are well within the scope of the present disclosure. Although the dimensions of the trailer stabilization system 100 are important design parameters for user convenience, the trailer stabilization system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trailer stabilizing system comprising:
a trailer;
a trailer frame;
a towing vehicle;
a plurality of sensors; and
a plurality of stabilizing arms;
wherein said plurality of sensors disposed in said trailer for monitoring said trailer stability and detecting swaying of said trailer from a first position to a second position;
wherein said plurality of sensors are selected from the group consisting of one or more of an accelerometer, a wind speed sensor, and a wind direction sensor; and
further wherein said plurality of stabilizing arms are disposed along and mounted to said trailer frame.

2. The trailer stabilizing system of claim 1, wherein said plurality of stabilizing arms counteract the swaying of said trailer and return said trailer from said second position to said first position.

3. The trailer stabilizing system of claim 2 further comprising a plurality of signaling items, wherein said plurality of signaling items mounted to said trailer for warning surrounding drivers when said plurality of sensors detecting swaying of said trailer.

4. The trailer stabilizing system of claim 3, wherein said plurality of signaling items selected from the group consisting of a light and a noise producing speaker.

5. The trailer stabilizing system of claim 4, wherein said light is selected from the group consisting of an LED light, a strobe light, a rotating beacon light, and a sequential light.

6. The trailer stabilizing system of claim 5, wherein said noise producing speaker is selected from the group consisting of an alarm tone, a pulsing sound, and a horn.

7. The trailer stabilizing system of claim 6 further comprising a GPS module, wherein said GPs module integrated with said trailer for providing a real-time location of said trailer.

8. The trailer stabilizing system of claim 7 further comprising a plurality of batteries for powering said plurality of sensors, said plurality of stabilizing arms, and said plurality of signaling items.

9. A trailer stabilizing system comprising:
a trailer;
a towing vehicle;
a plurality of sensors; and
a plurality of stabilizing arms;
wherein said plurality of sensors disposed in said trailer for monitoring said trailer stability and detecting swaying of said trailer from a first position to a second position;
wherein said plurality of sensors are selected from the group consisting of one or more of an accelerometer, a wind speed sensor, and a wind direction sensor;
wherein said plurality of stabilizing arms are disposed along and mounted to an interior of said trailer;
wherein said stabilizing arms are telescoping tubes; and
further wherein said stabilizing arms having actuators for retracting and extending said stabilizing arms to counteract the swaying of said trailer.

10. The trailer stabilizing system of claim 9, wherein said plurality of stabilizing arms counteract the swaying of said trailer and return said trailer from said second position to said first position.

11. The trailer stabilizing system of claim 10 further comprising a plurality of signaling items, wherein said plurality of signaling items mounted to said trailer for warning surrounding drivers when said plurality of sensors detecting swaying of said trailer, and further wherein said plurality of signaling items selected from the group consisting of a light and a noise producing speaker.

12. The trailer stabilizing system of claim 11, wherein said light is selected from the group consisting of an LED light, a strobe light, a rotating beacon light, and a sequential light.

13. The trailer stabilizing system of claim 12, wherein said noise producing speaker is selected from the group consisting of an alarm tone, a pulsing sound, and a horn.

14. The trailer stabilizing system of claim 13 further comprising a GPS module, wherein said GPs module integrated with said trailer for providing a real-time location of said trailer.

15. The trailer stabilizing system of claim 14 further comprising a plurality of batteries for powering said plurality of sensors, said plurality of stabilizing arms, and said plurality of signaling items.

16. A trailer stabilizing system comprising:
a trailer;
a towing vehicle;
a plurality of sensors;
a plurality of stabilizing arms; and
a plurality of signaling items;
wherein said plurality of sensors disposed in said trailer for monitoring said trailer stability and detecting swaying of said trailer from a first position to a second position;
wherein said plurality of sensors are selected from the group consisting of one or more of an accelerometer, a wind speed sensor, and a wind direction sensor;
wherein said plurality of stabilizing arms are disposed along and mounted to an interior of said trailer;
wherein said stabilizing arms are telescoping square cross-sectional tubes;
wherein said stabilizing arms having actuators for retracting and extending said stabilizing arms to counteract the swaying of said trailer;
wherein said plurality of signaling items mounted to said trailer for warning surrounding drivers when said plurality of sensors detecting swaying of said trailer; and
further wherein said plurality of signaling items selected from the group consisting of a light and a noise producing speaker.

17. The trailer stabilizing system of claim 16, wherein said plurality of stabilizing arms counteract the swaying of said trailer and return said trailer from said second position to said first position.

18. The trailer stabilizing system of claim 16, wherein said light is selected from the group consisting of an LED light, a strobe light, a rotating beacon light, and a sequential light.

19. The trailer stabilizing system of claim 16, wherein said noise producing speaker is selected from the group consisting of an alarm tone, a pulsing sound, and a horn.

20. The trailer stabilizing system of claim 16 further comprising a plurality of batteries for powering said plurality of sensors, said plurality of stabilizing arms, and said plurality of signaling items.
